(19) United States
(12) Patent Application Publication
(10) Pub. No.: US 2012/0135165 A1
(43) Pub. Date: May 31, 2012

(54) ANTIGLARE AND ANTISEPTIC COATING MATERIAL AND TOUCHSCREEN COATED WITH THE SAME

(76) Inventor: Yu-Hui Huang, Taoyuan County (TW)

(21) Appl. No.: 12/955,481

(22) Filed: Nov. 29, 2010

(51) Int. Cl. C09K 19/00; B32B 5/16; C07F 7/21; B82Y 30/00

(52) U.S. Cl. 428/1.32; 428/402; 428/1.4; 977/773

(57) ABSTRACT

An antiglare and antiseptic coating material comprises a nanometric spherical polymer molecule having the formula (I):

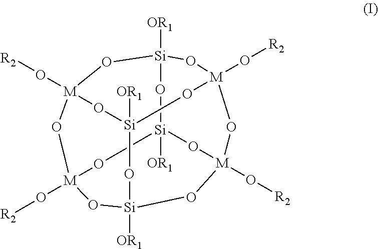

wherein R1 could be halogens, hydrogen, alkyl groups, alkoxy groups, the hydroxyl group, alkenyl groups, alkynyl groups, acyl groups, aryl groups, carboxyl groups, alkoxycarbonyl groups, or aryloxycarboxyl groups, and wherein R2 could be amino groups, thiol groups, phosphino groups, acid radicals, basic groups, alcohol groups, or alkyl groups, and wherein M's are identical metal atoms or different metal atoms which could be zirconium, copper, titanium, gold, platinum, or zinc. The antiglare and antiseptic coating material is spread on a conductive layer or an outer cover layer of a touchscreen to provide a durable, weather-resistant antiglare and antiseptic coating for the touchscreen. Further, the coating can dim fingerprints on the touchscreen.

### FIELD OF THE INVENTION

The present invention relates to a coating material and a touchscreen coated with the same, particularly to an antiglare and antiseptic coating material and a touchscreen coated with the same.

### BACKGROUND OF THE INVENTION

Display devices are widely used in various electronic products to function as media between users and information. Among them, LCD (Liquid Crystal Display) is a kind of mainstream display devices because of the characteristics including its slimness, low power consumption and low radiation.

Common display devices can only present information to users. If users want to operate electronic products or input instructions into electronic products, such as personal computers or notebook, they still need input devices, such as mice or keyboards, which would be a barrier for beginners to use electronic devices. Thus, touchscreens, which integrate a touch-control module with a display device, have been developed to realize intuitive operation.

In comparison with the conventional input devices that only have an information-presentation function (such as mice and keyboards), touchscreens not only can present information but also can realize intuitive operation of computers to effectively lower the threshold of operation and also promote the efficiency of input operation. Further, the technology of manufacturing touchscreens is growing gradually, and the manufacture cost also can be greatly reduced. Therefore, touchscreens have been widely applied to common consumer electronics, such as mobile communication devices, tablet computers, digital cameras, digital music players, personal digital assistants, and global positioning systems.

The current touchscreens can be categorized into the resistive type, the capacitive type, the surface acoustic wave type, and the optical imaging type. Among them, the resistive type and the capacitive type are more widely used.

The resistive touchscreen is formed of two ITO (Indium Tin Oxide) conductive layers joined vertically. Applying pressure to the touchscreen enables the conduction between the upper and lower electrodes. The controller detects the voltage variation and calculates the touched position to obtain the signal of the input position. For example, a U.S. Pat. No. 4,822,957 has been widely applied to a five-wire resistive touchscreen of Elo Touch Company. The resistive touchscreen comparing with other types of touchscreens has a lower cost and is popular in the current market. However, the service life of the resistive touchscreen could be shortened because of mechanical friction between components caused by pressing action in operation. Besides, the resistive touchscreen is unlikely to perform complicated instructions.

In a common capacitive touchscreen structure, a conductive layer, such as an ITO layer, is formed on a glass substrate, and electrode patterns are formed on the surface thereof, and then a protective film or an insulating layer is coated on the surface. Sometimes, an anti-noise layer can be arranged below the glass substrate to reduce environment interference. The working principle of the common capacitive touchscreen is that extra voltage supplies to four corners of the screen supply, and the electrode patterns form an electric field on the surface of the glass substrate. Touching the screen induces current and causes voltage drop in the touched position. According to the ratio of induced current from the touched position to the four corners that is detected by the controller, the controller can work out the touched position. U.S. Pat. No. 4,198,539, U.S. Pat. No. 4,293,734, U.S. Pat. No. 4,371,746, and U.S. Pat. No. 6,781,579, and a U.S. application Ser. No. 11/409,425 respectively disclosed technologies of capacitive touchscreens.

Users have to touch the surface of a touchscreen to input instructions or operate the computer, no matter what type the touch screen is. Electronic devices with touchscreens located in public spaces are very frequently used by many people and likely to spread microbes and bacteria.

In order to solve the abovementioned problem, some schemes intend to apply antiseptic materials to the surface of touchscreens. Common antiseptic materials could be antibiotics, nanometric inorganic antiseptic agents, or other organic antiseptic agents, which are gradually released to inhibit or kill bacteria. For example, a Taiwan patent No. I272110 disclosed a touchscreen with an antiseptic layer and a method for fabricating the same, wherein a type of antiseptic metallic particles having a diameter of 1-100 nm are uniformly coated on the surface of a touchscreen to form an antiseptic layer, and wherein the antiseptic metallic particles are made of gold, silver, copper, zinc, platinum, or a compound thereof. A Taiwan publication No. 200727163 disclosed a technology of forming an antiseptic layer on the top surface of the upper substrate of a touchscreen, and wherein the antiseptic layer may contain nanometric silver particles. The abovementioned antiseptic metallic materials have biochemical activity. When the antiseptic metallic material penetrates the cell walls of bacteria, it denatures intracellular enzyme proteins of bacteria and kills the bacteria. The service life of the antiseptic agents can be prolonged via modifying the concentration or decreasing the releasing speed. However, the antiseptic agents would be exhausted finally. Thus, it must be applied to the touchscreen once again. Besides, the above-mentioned nanometric metallic materials are hard to form secure bonding with a touchscreen but likely to adhere to the matters contacting it, such as user's fingers. Thus, the abovementioned antiseptic metallic materials may poison human beings and contaminate the environment.

In addition, U.S. Pat. No. 6,504,583 disclosed an antiseptic material for touchscreens, which is a derivative of an alkyl quaternary ammonium salt. The alkyl quaternary ammonium salt has positive charge. When contacting the negatively-charged surface of bacteria, the positively-charged alkyl quaternary ammonium salt destroys the charge balance of cell membranes, which may disable metabolism of the neighboring organelles or even rupture the cell membranes and expose the cytoplasm. In comparison with the abovementioned antiseptic metallic materials, the alkyl quaternary ammonium salt antiseptic agents needn't directly take part in bacteria-killing activity but functions as a catalyst to damage charge balance of cells. Therefore, the concentration of the alkyl quaternary ammonium salt antiseptic agents would be maintained. However, the alkyl quaternary ammonium salt antiseptic agents are also hard to form secure bonding with a touchscreen and likely to peel off from the touchscreen. Therefore, the antiseptic effect thereof will obviously decrease with usage.

When coated on the surface of a touchscreen, these kinds of conventional antiseptic materials would form a transparent film which makes the surface of the touchscreen very smooth and becomes a mirror-like (glassy) surface. Under intense light, the glassy surface generates glare that makes the user unable to view the contents presented on the touchscreen. On the other hand, when the user contacts a touchscreen with a dusty or oily finger, the dust or fingerprint will be left on the touchscreen and impair the appearance of the touchscreen.

### SUMMARY OF THE INVENTION

The primary objective of the present invention is to solve the problem that the conventional alkyl quaternary ammonium salt antiseptic agents would peel off from touchscreens, the problem that the conventional inorganic metallic antiseptic agents would stick to users' fingers and pollute the environment, and the problem that the conventional antiseptic agents would generate glare and visualize fingerprints.

To achieve the abovementioned objectives, the present invention provides an antiglare and antiseptic coating material, which contains a nanometric spherical polymer molecule having the formula (I):

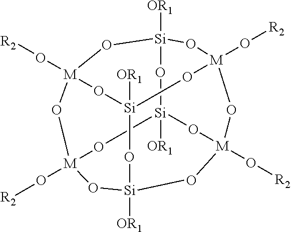

wherein R1 could be halogens, hydrogen, alkyl groups, alkoxy groups, the hydroxyl group, alkenyl groups, alkynyl groups, acyl groups, aryl groups, carboxyl groups, alkoxycarbonyl groups, or aryloxycarboxyl groups, and
wherein R2 could be the amino groups, the thiol groups, phosphino groups, acid radicals, basic groups, alcohol groups, or alkyl groups, and
wherein M's may be identical metal atoms or different metal atoms which could be zirconium, copper, titanium, platinum, gold, or zinc. The nanometric spherical polymer molecule have a diameter of 100-200 nm.

The present invention also discloses a touchscreen which has a conductive layer to be coated with the abovementioned antiglare and antiseptic coating material.

The present invention also discloses a touchscreen which has an outer cover to be coated with the abovementioned antiglare and antiseptic coating material.

In comparison with the conventional antiseptic agents applied to touchscreens, such as the alkyl quaternary ammonium salt antiseptic agents and the inorganic metallic antiseptic agents, the antiglare and antiseptic coating material of the present invention provides higher weather resistance and rapid and durable antiseptic effects for touchscreens. The antiglare and antiseptic coating material of the present invention would prevent from peeling off from touchscreens and can securely adhere to surfaces of touchscreens. Therefore, the antiglare and antiseptic coating material of the present invention neither poisons human bodies nor pollutes the environment. In the present invention, the nanometric spherical polymer molecules, which are uniformly distributed in the coating material coated on the surface of a touchscreen, scatter incident light, whereby is realized a matte (antiglare) screen. Further, the matte surface can exempt the appearance of touchscreens from being impaired by fingerprint or oily contamination.

### DETAILED DESCRIPTION OF THE PREFERRED EMBODIMENTS

The present invention discloses an antiglare and antiseptic coating material, which contains a nanometric spherical polymer molecule having the formula (I):

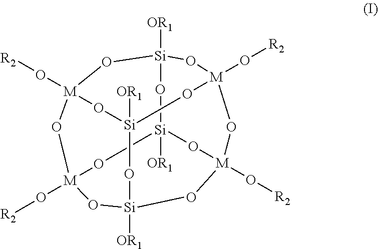

R1 could be halogens, hydrogen, alkyl groups, alkoxy groups, the hydroxyl group, alkenyl groups, alkynyl groups, acyl groups, aryl groups, carboxyl groups, alkoxycarbonyl groups, and aryloxycarboxyl groups. Further, R1 preferably could be —H, —OH, —OCH₃, —OC₂H₅, —CH₃, —CH═CH₂, —OC₂H₄OCH₃ or —C₃H₆COOC₂H₅. R2 could be the amino groups, the thiol groups, phosphino groups, acid radicals, basic groups, alcohol groups, or alkyl groups. In one embodiment, the amino groups of R2 could be trioctylamine groups, octylamine groups, dodecylamine groups, hexylamine groups, pyridyl groups, oleamine groups or quaternary ammonium groups. The thiol groups of R2 could be octylthiol groups, dodecylthiol groups, or thiophenol groups. The phosphino groups of R2 could be triphenylphosphonio groups, tributylphosphino groups, or trioctylphosphino groups. The acid radicals of R2 could be a sulfate radical, a nitrate radical, a chloride radical, an acetate radical, or a sodium sulfate radical. The basic groups of R2 could be the sodium radical, the potassium radical or the ammonium radical. The alcohol groups of R2 could be the methanol group, the ethanol group, the ethylene glycol group, the propanol group, or the isopropanol group. The alkyl groups of R2 could be the methane group, the ethane group, the propane group, the butane group, the pentane group, the hexane group, the heptane group, the octane group, the dodecane group, the tridecane group, the tetradecane group, the pentadecane group, the hexadecane group, the heptadecane group, or the octadecane group. M's may be identical metal atoms or different metal atoms which could be zirconium, copper, titanium, gold, platinum, or zinc.

The antiglare and antiseptic coating material of the present invention is fabricated by adding stabilizers into the sol-gel with silicon functional groups (SiOₓ) and organic and/or inorganic metal ions, wherein the silicon functional groups are used as the structural frames. The molecules in a sol-gel state are interacted mutually by non-covalent bonds, such as hydrogen bonds, Van der Waals force, and coordinate bonds, to form supermolecules. Thereby, the sol-gel has superior uniformity, dispersiveness and stability. After added into the abovementioned sol-gel, the stabilizers retard the growth of a portion of particles. Further, stable coordinate bonds form between the stabilizers and metal atoms, whereby a plurality of transparent spherical polymer particles is formed. In the present invention, the spherical polymer particles have a diameter of 100-200 nm. In the present invention the stabilizers could be organic amines (such as trioctylamine, octylamine, dodecylamone, hexylamine, pyridine, oleamine, quaternary ammonium groups), thiols (such as octylthiol groups, dodecylthiol groups, and thiophenol groups), phosphino compounds (such as triphenylphosphonio groups, tributylphosphino groups, and trioctylphosphino groups), acids (such as sulfuric acid, nitric acid, hydrochloric acid, acetic acid, and sodium sulfate), bases (such as sodium hydroxide, potassium hydroxide and ammonium hydroxide), alcohol groups (such as methanol, ethanol, ethylene glycol, propanol, and isopropanol), or alkyl groups (methane, ethane, propane, butane, pentane, hexane, heptane, octane, dodecane, tridecane, tetradecane, pentadecane, hexadecane, heptadecane, and octadecane).

The antiglare and antiseptic coating material of the present invention can be applied to various touchscreens. For example, the coating material of the present invention can be coated on a conductive layer inside a touchscreen, wherein the conductive layer is made of ITO (Indium Tin Oxide), ATO (Antimony Tin Oxide), AZO (Aluminum Zinc Oxide), or IZO (Indium Zinc Oxide). The coating material can also be coated on the outer cover of a touchscreen, wherein the outer cover is made of glass, PMMA (poly(methyl methacrylate)), PVC (polyvinyl chloride), PC (polycarbonate), PET (poly(ethylene terephthate)), or PI (polyimide).

The coating material is coated on a surface to form a thin layer. The thin layer is sintered at a high temperature to have superior weather resistance and hardness and function like glass. After sintering, strong covalent bonds form between the coated surface and the silicon functional groups of the nanometric spherical polymer molecules. Thus, the antiseptic layer is hard to peel off from the coated surface, and the antiseptic effect would still be maintained after long term usage. The spherical polymer particles are stable nanometric particles uniformly distributed and having superior monodispersion. The coating material coated on a surface forms a transparent matte structure, and the spherical particles thereinside scatter incident light to realize an antiglare effect. The spherical polymer particle has a great surface-area-to-volume ratio. The bonding state and electronic state on the surface of the spherical polymer particle are different from those inside the spherical polymer particle. Further, incomplete atomic coordinating on the surface of the spherical polymer particle makes the surface have many active sites in form of high valence oxide having very high potential to be reduced. The high valance oxide intensively catalyzes oxygen of air and humidity in the surrounding to form active oxygen ions (such as O₃) and hydroxyl free radicals. The active oxygen ions have powerful oxidizing ability and can penetrate into bacteria and viruses to denature proteins and damage the enzyme system, whereby bacteria and viruses are killed. In the present invention, the antiseptic mechanism is implemented by the atomic oxygen generated by the high valence oxide having very high potential to be reduced. Therefore, the antiseptic process of the present invention is harmless to human beings and the environment.

The negatively-charged bacteria having a size of about 1 μm are attracted by intense columbic force to the inorganic metal ions having a size of 30-40 nm and existing inside the spherical polymer particle. The inorganic metal ions penetrate the cell walls and integrate with phospholipids and cholesterol of plasmalemma with the permeability of plasmalemma being increased. Thus, the cell walls are broken into fragments having a size of less than 60 nm. Further, the surface layer of a bacterium is induced to have negative charge that makes the surface charge non-uniformly distribute and damages the electric charge equilibrium of the electron transfer system, metabolism system and mass transfer system inside the bacterium. Furthermore, the inorganic metal ions react with the thiol groups, inducing protein coagulation and damaging the activity of the synthase. Thus, the bacteria or microbes contacting the inorganic metal ions lose ability of division and breeding. The antiseptic component of the present invention can inactivate or kill bacteria and microbes without any consumption. Thus, the quantity of the antiseptic component is always maintained to keep the antiseptic effect thereof durable. The outmost protective layer of human skin has a thickness of about 1-2 mm, which is about 1,000 times greater than the size of a bacterium and about 100,000 times greater than the size of the inorganic metal ion. Therefore, the antiseptic component of the present invention would not harm cortical cells of human beings but only inactivate or kill bacteria.

Below are described in detail the embodiments of the present invention to demonstrate the method for fabricating a touchscreen coated with the antiglare and antiseptic coating material, the abrasion resistance or antiseptic effect thereof.

### Embodiment I

### A Process to Fabricate a Touchscreen Coated with an Antiglare and Antiseptic Coating Material

Firstly, the antiglare and antiseptic coating material having a nanometric spherical polymer molecule having the formula (I) is directly coated on a PMMA outer cover. Alternatively, the antiglare and antiseptic coating material is diluted and then coated on a PMMA outer cover. The antiglare and antiseptic coating material can be diluted with a solvent selected from a group consisting of alcohol groups (such as isopropanol or ethanol), ketone groups, ether groups, and benzene. In the present invention, the antiglare and antiseptic coating material can be diluted with 1000 times of solvent to have a concentration of 0.1 v/v %. In dilution, the antiglare and antiseptic coating material is mixed with a solvent to form a mixture solution, and the mixture solution is agitated in a mechanical way. For example, the mixture solution is agitated with blades; or the mixture solution is agitated with a rotation agitator; the mixture solution is oscillated up and down; the mixture solution is contained in a roller, and the roller is rolled back and forth. Thereby a stable, homogeneous and high-monodispersion antiseptic material solution containing nanometric spherical polymer molecules is attained. In the present invention, the antiseptic coating material solution containing the nanometric spherical polymer molecule is coated on an outer cover of a touchscreen via spraying, dipping, printing, spin-coating, or manual smearing. Next, the outer cover coated with the antiseptic coating material is placed in an environment at a temperature of 50-1000° C. for at least one minute, whereby the coating material securely adheres to the outer cover. Then, the outer cover is cooled down. Thus an antiglare and antiseptic coating on the outer cover is formed. The controllable gloss of the antiglare and antiseptic coating ranges from 15 to 150.

### Embodiment II

### Surface Tests of Outer Covers Coated with an Antiglare and Antiseptic Coating Material

Respectively perform surface energy tests, water droplet diameter tests, oil droplet diameter tests and fingerprint tests on coated outer covers (experimental groups) and uncoated outer covers (control groups).

### (1) Surface Energy Tests:

A dyne pen is used to undertake surface energy tests. All the results of the experimental group are greater than 50 dynes/cm. The result of a common glass substrate is 47 dynes/cm.

### (2) Water Droplet Diameter Tests:

20 pieces of 5 cm×5 cm coated outer covers (an experimental group) and 20 pieces of 5 cm×5 cm uncoated outer covers (a control group) are prepared. 0.1 c.c. of water is dripped on the abovementioned two groups of outer covers, and the diameters of the water droplets on the outer covers could be measured. The results are as follows:

| | | Result of |
|---|---|---|
| Serial Number of | Result of Control | Experimental |
| Group | Group (cm²) | Group (cm²) |
| 1 | 0.5 | 0.9 |
| 2 | 0.4 | 0.8 |
| 3 | 0.5 | 0.9 |
| 4 | 0.5 | 0.9 |
| 5 | 0.5 | 1.0 |
| 6 | 0.5 | 0.9 |
| 7 | 0.5 | 0.9 |
| 8 | 0.4 | 0.8 |
| 9 | 0.5 | 0.9 |
| 10 | 0.5 | 1.0 |
| 11 | 0.5 | 0.9 |
| 12 | 0.5 | 0.9 |
| 13 | 0.5 | 0.9 |
| 14 | 0.5 | 1.0 |
| 15 | 0.5 | 0.9 |
| 16 | 0.4 | 0.8 |
| 17 | 0.5 | 0.9 |
| 18 | 0.5 | 0.9 |
| 19 | 0.5 | 0.9 |
| 20 | 0.5 | 0.9 |

The results show that all the droplet diameters of the experimental group are greater than 0.8 cm² and that the droplet diameters of the control group are about 0.5 cm².

### (3) Oil Droplet Diameter Tests:

20 pieces of 5 cm×5 cm coated outer covers (an experimental group) and 20 pieces of 5 cm×5 cm uncoated outer covers (a control group) are prepared. 0.1 c.c. of oil is dripped on the abovementioned two groups of outer covers, and the diameters of the oil droplets on the outer covers could be measured. The results are as follows:

| | | Result of |
|---|---|---|
| Serial Number of | Result of Control | Experimental |
| Group | Group (mm²) | Group (mm²) |
| 1 | 50 | 90 |
| 2 | 50 | 90 |
| 3 | 50 | 90 |
| 4 | 40 | 80 |
| 5 | 50 | 90 |
| 6 | 50 | 100 |
| 7 | 50 | 90 |
| 8 | 40 | 80 |
| 9 | 40 | 80 |
| 10 | 40 | 80 |
| 11 | 50 | 90 |
| 12 | 50 | 100 |
| 13 | 50 | 90 |
| 14 | 50 | 90 |
| 15 | 50 | 90 |
| 16 | 40 | 80 |
| 17 | 50 | 90 |
| 18 | 50 | 90 |
| 19 | 40 | 80 |
| 20 | 50 | 100 |

The results show that all the droplet diameters of the experimental group are greater than 80 mm² and that the droplet diameters of the control group are about 50 mm².

### (4) Fingerprint Tests:

20 pieces of 5 cm×5 cm coated outer covers are prepared. A gloss meter is used to test the gloss of the coated outer covers before and after making fingerprints thereon. The results are as follows:

| | Results Before | Results After |
|---|---|---|
| | Making | Making |
| Serial Number of | Fingerprints | Fingerprints |
| Group | (gloss) | (gloss) |
| 1 | 115 | 114 |
| 2 | 105 | 105 |
| 3 | 111 | 111 |
| 4 | 110 | 110 |
| 5 | 109 | 108 |
| 6 | 115 | 115 |
| 7 | 119 | 119 |
| 8 | 115 | 115 |
| 9 | 120 | 119 |
| 10 | 110 | 110 |
| 11 | 110 | 111 |
| 12 | 117 | 115 |
| 13 | 110 | 110 |
| 14 | 115 | 110 |
| 15 | 110 | 110 |
| 16 | 115 | 115 |
| 17 | 116 | 116 |
| 18 | 110 | 111 |
| 19 | 110 | 110 |
| 20 | 118 | 115 |

The results show that the outer cover coated with the antiglare and antiseptic coating material have gloss of 110±10 before and after making fingerprints thereon.

From the results of the above four tests, it is known that the outer cover coated with the antiglare and antiseptic coating material is lipophilic and able to swell the oil of fingerprints and dim the fingerprints. Therefore, the coating material can solve the problem that fingerprints impair the appearance and visibility of the touchscreen coated with the conventional antiseptic agents.

### Embodiment III

### Weather Resistance Tests of Outer Covers Coated with an Antiglare and Antiseptic Coating Material

High temperature tests, low temperature tests, high humidity tests and thermal shock tests on coated outer covers are performed as follows.

### (1) High Temperature Tests:

20 pieces of 5 cm×5 cm coated outer covers are prepared. A gloss meter is used to test the gloss of the coated outer covers initially and test it again after the outer covers are placed in an environment at a temperature of 80° C. for 200 hours. The results are as follows:

| | Results Before | Results After |
|---|---|---|
| | Placed at High | Placed at High |
| Serial Number of | Temperature | Temperature |
| Group | (gloss) | (gloss) |
| 1 | 115 | 115 |
| 2 | 115 | 113 |
| 3 | 111 | 111 |
| 4 | 110 | 110 |
| 5 | 109 | 108 |
| 6 | 115 | 115 |
| 7 | 116 | 117 |
| 8 | 115 | 115 |
| 9 | 110 | 119 |
| 10 | 110 | 110 |
| 11 | 110 | 111 |
| 12 | 117 | 115 |
| 13 | 110 | 110 |
| 14 | 115 | 115 |
| 15 | 118 | 118 |
| 16 | 115 | 115 |
| 17 | 116 | 116 |
| 18 | 110 | 111 |
| 19 | 110 | 110 |
| 20 | 117 | 115 |

### (2) Low Temperature Tests:

20 pieces of 5 cm×5 cm coated outer covers are prepared. A gloss meter is used to test the gloss of the coated outer covers initially and test it again after the outer covers are placed in an environment at a temperature of −40° C. for 150 hours. The results are as follows:

| | Results Before | Results After |
|---|---|---|
| | Placed at Low | Placed at Low |
| Serial Number of | Temperature | Temperature |
| Group | (gloss) | (gloss) |
| 1 | 115 | 114 |
| 2 | 110 | 110 |
| 3 | 111 | 111 |
| 4 | 110 | 110 |
| 5 | 109 | 108 |
| 6 | 115 | 115 |
| 7 | 110 | 115 |
| 8 | 115 | 115 |
| 9 | 110 | 110 |
| 10 | 110 | 110 |
| 11 | 110 | 110 |
| 12 | 117 | 115 |
| 13 | 110 | 110 |
| 14 | 115 | 110 |
| 15 | 110 | 110 |
| 16 | 115 | 115 |
| 17 | 116 | 116 |
| 18 | 110 | 111 |
| 19 | 110 | 110 |
| 20 | 115 | 115 |

### (3) High Humidity Tests:

20 pieces of 5 cm×5 cm coated outer covers are prepared. A gloss meter is used to test the gloss of the coated outer covers initially and test it again after the outer covers are placed in an environment at a temperature of 50° C. and a relative humidity of 50% for 200 hours. The results are as follows:

| | Results Before | Results After |
|---|---|---|
| | Placed at High | Placed at High |
| Serial Number of | Humidity | Humidity |
| Group | (gloss) | (gloss) |
| 1 | 115 | 116 |
| 2 | 105 | 105 |
| 3 | 111 | 113 |
| 4 | 110 | 110 |
| 5 | 109 | 108 |
| 6 | 115 | 115 |
| 7 | 110 | 110 |
| 8 | 115 | 115 |
| 9 | 120 | 119 |
| 10 | 110 | 110 |
| 11 | 110 | 111 |
| 12 | 117 | 115 |
| 13 | 110 | 110 |
| 14 | 115 | 116 |
| 15 | 110 | 110 |
| 16 | 115 | 115 |
| 17 | 116 | 116 |
| 18 | 110 | 111 |
| 19 | 110 | 110 |
| 20 | 115 | 115 |

### (4) Thermal Shock Tests:

20 pieces of 5 cm×5 cm coated outer covers are coated. A gloss meter is used to test the gloss of the coated outer covers initially and test it again after the outer covers are placed at a temperature of 80° C. for 15 minutes and then −40° C. for 30 minutes cyclically 40 times. The results are as follows:

| | Results Before | Results After |
|---|---|---|
| Serial Number of | Thermal Shock | Thermal Shock |
| Group | (gloss) | (gloss) |
| 1 | 115 | 115 |
| 2 | 105 | 105 |
| 3 | 112 | 111 |
| 4 | 110 | 110 |
| 5 | 109 | 108 |
| 6 | 115 | 115 |
| 7 | 110 | 110 |
| 8 | 115 | 115 |
| 9 | 120 | 119 |
| 10 | 110 | 110 |
| 11 | 110 | 110 |
| 12 | 117 | 117 |
| 13 | 110 | 109 |
| 14 | 115 | 114 |
| 15 | 110 | 110 |
| 16 | 115 | 115 |
| 17 | 116 | 116 |
| 18 | 110 | 111 |
| 19 | 110 | 110 |
| 20 | 116 | 115 |

The results of the above several weather resistance tests prove that the outer cover coated with the antiglare and antiseptic coating material passes the tests of high temperature, low temperature, high humidity and thermal shock and has superior weather resistance.

### Embodiment IV

### Antiseptic Effect Tests of the Outer Covers Coated with the Antiglare and Antiseptic Coating Material

The Escherichia coli of Gram positive bacteria are used to verify the effect of the antiseptic touchscreen of the present invention. 20 pieces of 5 cm² PMMA outer covers coated with the antiglare and antiseptic coating material containing a nanometric spherical polymer molecule having the formula (I) (an experimental group) and 20 pieces of 5 cm² uncoated PMMA outer covers (a control group) are prepared respectively. 10⁵ CFU/ml Escherichia coli are spread onto the outer covers of the experimental group and the control group respectively. Next, incubate these outer covers are incubated at a temperature of 35° C. for 24 hours. Next, the incubated outer covers are flushed with 50 ml of a sterile phosphate buffer to remove dead Escherichia coli. Next, the bacteria colonies surviving on the outer covers are counted. The results are as follows:

| | | Results of |
|---|---|---|
| Serial Number of | Results of Control | Experimental |
| Group | Group (CFU/ml) | Group (CFU/ml) |
| 1 | 4.0*10⁵ | 7.0*10² |
| 2 | 3.8*10⁶ | 1.0*10³ |
| 3 | 5.0*10⁵ | 1.5*10³ |
| 4 | 4.1*10⁵ | 9.1*10² |
| 5 | 7.0*10⁵ | 1.0*10³ |
| 6 | 2.0*10⁶ | 2.2*10³ |
| 7 | 4.3*10⁵ | 4.8*10² |
| 8 | 6.0*10⁵ | 3.6*10² |
| 9 | 3.0*10⁵ | 3.0*10² |
| 10 | 2.8*10⁵ | 8.0*10¹ |
| 11 | 4.4*10⁵ | 6.4*10² |
| 12 | 1.0*10⁶ | 1.7*10³ |
| 13 | 1.4*10⁶ | 6.5*10³ |
| 14 | 2.2*10⁵ | 1.2*10² |
| 15 | 5.0*10⁵ | 8.3*10² |
| 16 | 4.3*10⁷ | 6.3*10² |
| 17 | 4.0*10⁶ | 4.1*10² |
| 18 | 2.9*10⁶ | 6.9*10² |
| 19 | 4.0*10⁷ | 4.7*10⁴ |
| 20 | 3.9*10⁵ | 1.0*10³ |

From the results, it is known: only rare Escherichia coli could survive on the coated outer covers, and normal quantities of Escherichia coli still survive on the uncoated outer covers. Therefore, the outer covers coated with the antiglare and antiseptic coating material of the present invention have much higher antiseptic effect than the uncoated outer covers.

### Embodiment V

### Weather Resistance Tests of the Antiseptic Effect of the Outer Covers Coated with the Antiglare and Antiseptic Coating Material of the Present Invention

In this embodiment, high temperature tests, low temperature tests, high humidity tests and thermal shock tests are performed on PMMA outer covers coated with the antiglare and antiseptic coating material (an experimental group) and uncoated PMMA outer covers (a control group) respectively. 10⁵ CFU/ml Escherichia coli are spread onto the outer covers of the experimental group and the control group. Next, these outer covers are incubated at a temperature of 35° C. for 24 hours. Next, the incubated outer covers are flushed with 50 ml of a sterile phosphate buffer to remove dead Escherichia coli. Next, the bacteria colonies surviving on the outer covers are counted.

### (1) High Temperature Tests:

5 pieces of 5 cm×5 cm coated outer covers (an experimental group) and 5 pieces of 5 cm×5 cm uncoated outer covers (a control group) are prepare respectively. These prepared outer covers are placed in an environment at a temperature of 80° C. for 200 hours. Then, the antiseptic effect tests mentioned above are undertaken. The results are as follows:

| | | Results of |
|---|---|---|
| Serial Number | Results of Control | Experimental |
| of Group | Group (CFU/ml) | Group (CFU/ml) |
| 1 | 2.9*10⁶ | 2.2*10³ |
| 2 | 4.0*10⁷ | 4.7*10⁴ |
| 3 | 1.4*10⁶ | 1.7*10³ |
| 4 | 2.2*10⁵ | 9.5*10² |
| 5 | 7.0*10⁵ | 1.2*10² |

### (2) Low Temperature Tests:

5 pieces of 5 cm×5 cm coated outer covers (an experimental group) and 5 pieces of 5 cm×5 cm uncoated outer covers (a control group) are prepared respectively. These prepared outer covers are placed in an environment at a temperature of −40° C. for 150 hours. Then, the antiseptic effect tests mentioned above are undertaken. The results are as follows:

| | | Results of |
|---|---|---|
| Serial Number of | Results of Control | Experimental |
| Group | Group (CFU/ml) | Group (CFU/ml) |
| 1 | 4.0*10⁵ | 5.0*10² |
| 2 | 3.8*10⁶ | 3.0*10² |
| 3 | 6.0*10⁵ | 6.5*10² |
| 4 | 2.8*10⁵ | 1.5*10² |
| 5 | 4.4*10⁵ | 3.6*10² |

### (3) High Humidity Tests:

5 pieces of 5 cm×5 cm coated outer covers (an experimental group) and 5 pieces of 5 cm×5 cm uncoated outer covers (a control group) are prepared respectively. These prepared outer covers are placed in an environment at a temperature of 50° C. and a relative humidity of 50% for 200 hours. Then, the antiseptic effect tests mentioned above are undertaken. The results are as follows:

| | | Results of |
|---|---|---|
| Serial Number of | Results of Control | Experimental |
| Group | Group (CFU/ml) | Group (CFU/ml) |
| 1 | 4.3*10⁵ | 2.8*10² |
| 2 | 6.0*10⁵ | 3.6*10² |
| 3 | 2.2*10⁵ | 6.0*10² |
| 4 | 5.0*10⁵ | 8.0*10² |
| 5 | 4.3*10⁷ | 1.7*10³ |

### (4) Thermal Shock Tests:

5 pieces of 5 cm×5 cm coated outer covers (an experimental group) and 5 pieces of 5 cm×5 cm uncoated outer covers (a control group) are prepared respectively. The prepared outer covers are placed at a temperature of 80° C. for 15 minutes and then −40° C. for 30 minutes cyclically 40 times. Then, the antiseptic effect tests mentioned above are undertaken. The results are as follows:

| | | Results of |
|---|---|---|
| Serial Number of | Results of Control | Experimental |
| Group | Group (CFU/ml) | Group (CFU/ml) |
| 1 | 5.0*10⁵ | 1.2*10² |
| 2 | 4.3*10⁷ | 1.7*10⁴ |
| 3 | 5.0*10⁵ | 6.4*10² |
| 4 | 4.1*10⁵ | 2.7*10² |
| 5 | 7.0*10⁵ | 8.0*10² |

The results show that 99.99% of the E. coli on the outer covers coated with the antiglare and antiseptic coating material of the present invention are killed even after the weather resistance tests. Therefore, high temperature, low temperature, high humidity and thermal shock would not affect the antiseptic function of the present invention.

In the present invention, the antiglare and antiseptic coating material uses a nanometric spherical polymer molecule containing silicon functional groups and inorganic metal ions to inactivate or kill bacteria. Covalent bonds form stably between the silicon functional groups of the nanometric molecule and the touchscreen. Thus, the coating material of the present invention would not peel off from the surface of touchscreens. Therefore, the coating material of the present invention neither loses its antiseptic effect after long term usage nor pollutes the environment. Further, after being uniformly spread on the surface of a touchscreen, the coating material containing the nanometric spherical polymer molecules forms a matte surface. The nanometric spherical polymer molecules scatter incident light to realize an antiglare effect. Furthermore, the matte surface can prevent the appearance of touchscreens from being affected by dirt or fingerprints.

The present invention possesses utility, novelty and non-obviousness and meets the condition for a patent. Thus, the Inventor files the application for a patent. It will be appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. An antiglare and antiseptic coating material comprising
a nanometric spherical polymer molecule having the formula (I): 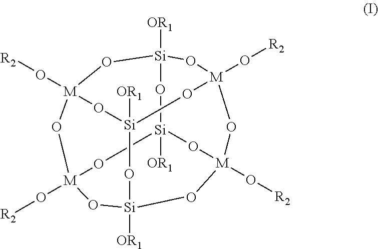
wherein R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups; and
wherein R2 is selected from a group consisting of amino groups, thiol groups, phosphino groups, acid radicals, basic groups, alcohol groups, and alkyl groups, and
wherein M's are identical metal atoms or different metal atoms selected from a group consisting of zirconium, copper, titanium, gold, platinum, and zinc.

2. The antiglare and antiseptic coating material according to claim 1, wherein R1 of the formula (I) is selected from a group consisting of —H, —OH, —OCH₃, —OC₂H₅, —CH₃, —CH═CH₂, —OC₂H₄OCH₃ and —C₃H₆COOC₂H₅.

3. The antiglare and antiseptic coating material according to claim 1, wherein the amino groups of R2 of the formula (I) are selected from a group consisting of trioctylamine groups, octylamine groups, dodecylamine groups, hexylamine groups, pyridyl groups, oleamine groups and quaternary ammonium groups.

4. The antiglare and antiseptic coating material according to claim 1, wherein the thiol groups of R2 of the formula (I) are selected from a group consisting of octylthiol groups, dodecylthiol groups, and thiophenol groups.

5. The antiglare and antiseptic coating material according to claim 1, wherein the phosphino groups of R2 of the formula (I) are selected from a group consisting of triphenylphosphonio groups, tributylphosphino groups, and trioctylphosphino groups.

6. The antiglare and antiseptic coating material according to claim 1, wherein the acid radicals of R2 of the formula (I) are selected from a group consisting of a sulfate radical, a nitrate radical, a chloride radical, an acetate radical, and a sodium sulfate radical.

7. The antiglare and antiseptic coating material according to claim 1, wherein the basic groups of R2 of the formula (I) are selected from a group consisting of a sodium radical, a potassium radical and an ammonium radical.

8. The antiglare and antiseptic coating material according to claim 1, wherein the alcohol groups of R2 of the formula (I) are selected from a group consisting of a methanol group, an ethanol group, an ethylene glycol group, a propanol group, and an isopropanol group.

9. The antiglare and antiseptic coating material according to claim 1, wherein the alkyl groups of R2 of the formula (I) are selected from a group consisting of a methane group, an ethane group, a propane group, a butane group, a pentane group, a hexane group, a heptane group, an octane group, a dodecane group, a tridecane group, a tetradecane group, a pentadecane group, a hexadecane group, a heptadecane group, and an octadecane group.

10. The antiglare and antiseptic coating material according to claim 1, wherein the nanometric spherical polymer molecule has a diameter of 100-200 nm.

11. A touchscreen coated comprising a conductive layer where the antiglare and antiseptic coating material according to claim 1 is coated.

12. The touchscreen according to claim 11, wherein the conductive layer is made of ITO (Indium Tin Oxide), ATO (Antimony Tin Oxide), AZO (Aluminum Zinc Oxide), or IZO (Indium Zinc Oxide).

13. A touchscreen coated comprising an outer cover where the antiglare and antiseptic coating material according to claim 1 is coated.

14. The touchscreen according to claim 13, wherein the outer cover is made of glass, poly(methyl methacrylate), polyvinyl chloride, polycarbonate, poly(ethylene terephthate), or polyimide).
